(19) United States
(12) Patent Application Publication
(10) Pub. No.: US 2005/0092952 A1
(43) Pub. Date: May 5, 2005

(54) Proportional poppet valve

(76) Inventors: Vincent P. McCarroll, Monroe, CT (US); R. Edwin Howe, New Canaan, CT (US); Blake D. Carter, New Canaan, CT (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/979,891

(22) Filed: Nov. 2, 2004

Related U.S. Application Data
(60) Provisional application No. 60/516,961, filed on Nov. 3, 2003.

(51) Int. Cl. F16K 31/02; E03B 1/00; E03C 1/00; F17D 1/00

(52) U.S. Cl. 251/129.18

(57) ABSTRACT

In order to provide proportional control of a poppet valve or a gate valve, adapted for fluid power applications, an electrical voice coil is used to move the gating element. Further, a preferred embodiment includes a feedback means for detecting and regulating the position of the gating element, for example to compensate for any perturbing mechanical vibrations. The result is a valve which closes securely, is infinitely variable within a range, and can make up to a full stroke, from fully closed to fully open, within 3 to 10 milliseconds, compared to the 15 milliseconds needed by a solenoid. Due to its fast response time, the improved valve mechanism provides much faster tracking of any changes in an applied command signal. Suitable applications are mechanical testing devices, and other repetitive motions situations, such as industrial automation and animatronics.

### FIELD OF THE INVENTION

The present invention relates generally to a poppet valve and more particularly to a proportional poppet valve adjusted by an electrical voice coil.

### BACKGROUND

A variety of means are known to electrically actuate a poppet valve, including torque motors, force motors, solenoids, and piezoelectrics. However, it is desirable for a poppet valve?s response to control inputs to be both proportional and linear, and the conventional approaches do not achieve these goals. It is known, from U.S. Pat. Nos. 5,460,201 & 5,960,831, BORCEA et al., assigned to the assignee of the present invention, to electrically actuate a spool-and-sleeve pneumatic valve by using a voice coil. However, spool-and-sleeve valves are not appropriate for all applications, because such valves do not always maintain a reliably tight seal in the closed position.

### SUMMARY OF THE INVENTION

We have found that using an electrical voice coil to actuate a poppet valve provides a linear displacement response which is proportional to the current input signal. Similar electrical actuators can be used with other types of valves, such as a gate or guillotine valve, a throttle valve or a globe valve. Voice coil actuated valves are more advantageous than prior art solenoid actuated valves because voice coil actuation permits adjustment to a variety of partially open positions, provides significantly faster operation than with a solenoid, and is resistant to external vibration influences.

According to a preferred embodiment of the invention, a feedback control circuit maintains or restores the valve to a commanded or desired position.

A suitable feedback circuit incorporates a transconductance amplifier.

The invention is particularly suited for use in industrial automation, animatronics, or other contexts requiring rapidly recycling or repetitive motion. Fluid power applications, including pneumatic and hydraulic valves, are suitable fields of use.

### BRIEF FIGURE DESCRIPTION

FIG. 1 is a cross-sectional view of a directly coupled poppet valve embodiment;

FIG. 2 is a cross-sectional view of a directly coupled gate valve embodiment;

FIG. 3 is a schematic diagram of a transconductance amplifier suitable for use in feedback control of a voice coil actuated valve;

FIG. 4 is a perspective view of a throttle valve embodiment having a linkage comprising a slider, connecting rod and crank;

FIG. 5 is a perspective view of a globe valve embodiment comprising a rack and pinion linkage.

### DETAILED DESCRIPTION

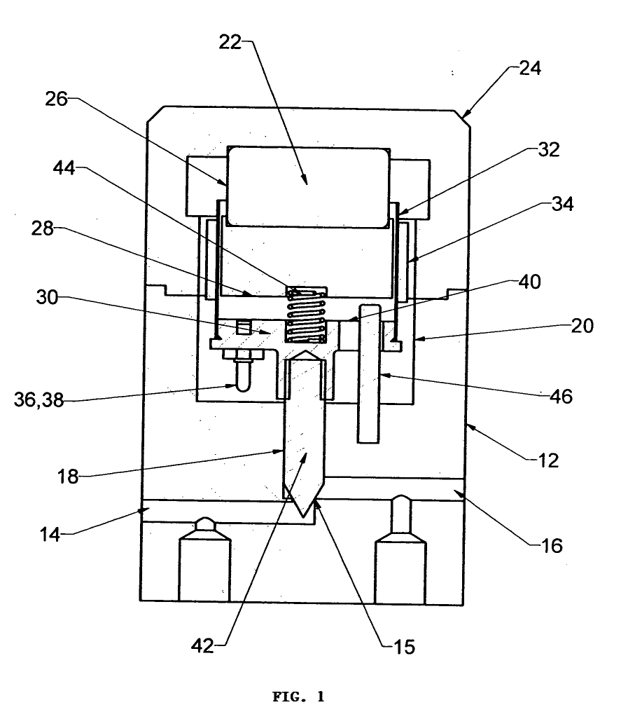

FIG. 1 illustrates a preferred embodiment of the present invention, namely a poppet valve 10. The valve has a valve body 12, an inlet passage 14, an outlet passage 16, and a valve seat 15 between the inlet and outlet passages. A vertical passage 18 above seat 15 provides a channel for a poppet or plug 42 and serves as a bearing surface for the poppet or plug. Various modifications are possible, as will be apparent to those of ordinary skill in the valve art. For example, the orientations of the passages can be varied.

Valve body 12 is formed with an internal cavity 20 which accommodates the actuating elements. A magnet housing assembly 22 sits atop valve body 12, and includes a magnet cover 24, a permanent magnet 26, and a pole piece 28 arranged beneath magnet 26. Beneath pole piece 28, a voice coil subassembly 30 is inserted. This comprises a hollow coil form 32, which supports a coil winding 34, having a pair of terminals 36, 38, pressed into a coil header 40.

Energizing the voice coil quickly drives the poppet a desired displacement, typically completing up to a full stroke from fully closed to fully open within 3 to 10 milliseconds. By contrast, when charging of a solenoid begins, it typically takes at least 5 milliseconds to move at all, and about 15 milliseconds to complete a full stroke; partial strokes are not possible.

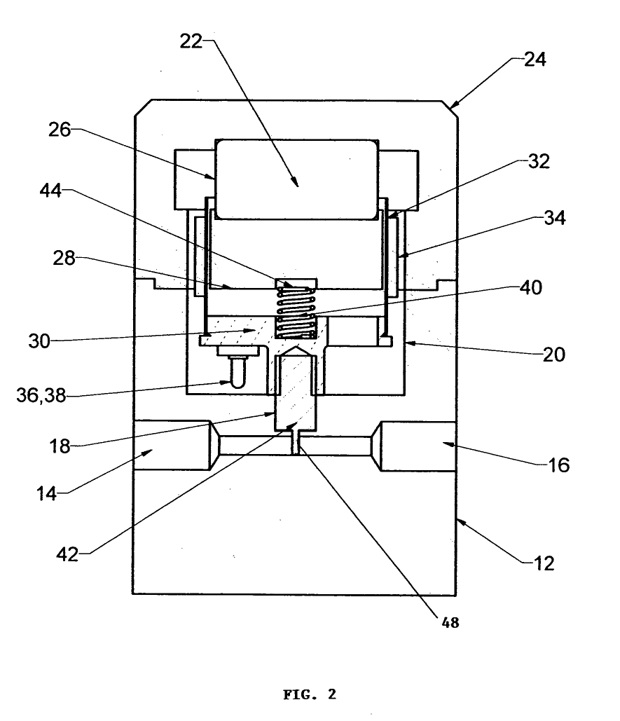

Means are provided for preventing rotation of the voice coil subassembly with respect to the valve body 12; this could be an anti-rotation header pin 46 (shown in FIG. 2) or could be a non-circular shape of the voice coil itself, such as a triangular or square coil cross-section. A poppet or plug 42 rides in channel 18, directly coupled to the movable coil. A biasing means, such as a spring 44 mounted in a recess on the underside of pole piece 28, biases the poppet in a preferred position, e.g. downward against valve seat 15. A header pin 46 runs between valve body 12 and coil header 40, and serves to prevent rotation of the voice coil subassembly 30 with respect to the valve body 12. Rotation of the voice coil subassembly is undesired, since such rotation would tend to tangle wire connections to coil terminals 36, 38.

FIG. 2 illustrates a second embodiment of the invention, namely a gate valve. The components are largely the same as those of the FIG. 1 embodiment, except that poppet 42 is connected to a gate or guillotine 48 which separates inlet passage 14 from outlet passage 16. Other configurations of the passages are possible, e.g. a rectangular cross-section. Spring 40 normally biases poppet 42 downwardly, so that gate or guillotine 48 closes off the passage.

When the voice coil is energized, it is stronger than the spring force, so that poppet 42 and gate 48 move upward, partially or completely opening the passage, depending upon the amplitude of the coil current, and compressing spring 40. When the coil current declines, spring 40 expands again.

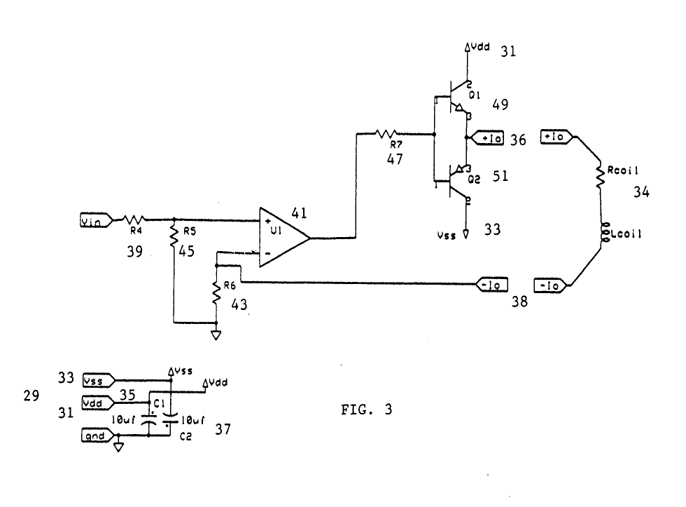

FIG. 3 is a schematic diagram of a feedback circuit, incorporating a transconductance amplifier, which serves to maintain the movable element of the valve in a commanded or desired position. A valve is typically used in a larger apparatus which has other moving parts or is subject to vibration or oscillation arising from external sources. In the worst case, the external vibration may be at a frequency which coincides with a natural resonant frequency of the valve. When such an external influence perturbs a voice coil with respect to its permanent magnet, a voltage change occurs in the coil winding. This voltage change can be detected, and used to specify and apply a current to drive the voice coil back to its previous position. This cancels the effect of the external vibration, and maintains the coil and valve at the desired setting and position. As shown in the example of FIG. 3, a power source provides operating voltage Vₛₛ of 12 volts; which is filtered by filter capacitors C1 and C2 to smooth out any irregularities in the supply voltage.

A command voltage value comes into the circuit at Vᵢₙ and is applied to the positive input of an operational amplifier (op-amp) . The negative input of the op-amp receives a feedback signal from the voice coil. If there is a difference between the two input signals of the op-amp, the op-amp sends a voltage through a resistor R7 to the gates of an NPN transistor Q1 and a PNP transistor Q2, which is connected in series with Q1. The switch-on voltage values of these transistors are selected such that, if more energy needs to be applied to the voice coil, first transistor Q1 switches on, allowing current to flow between its emitter and collector, and then through the voice coil, shown at right. Conversely, if less energy in the coil is desired, Q2 switches on, allowing current to pass from coil input terminal +Iₒ between the emitter and collector of Q2 to the negative line V_{DD} of the power supply, thereby bleeding energy out of the coil. In this way, the coil moves back to the configuration commanded by the original command signal Vᵢₙ. When the op-amp ceases to detect a difference between its input signals, it ceases to apply a voltage sufficient to turn on transistors Q1 or Q2, so they turn off.

Since the voice coil can move within a few milliseconds of application of driving current signals, the feedback circuit can compensate for even rapidly varying perturbing mechanical vibrations.

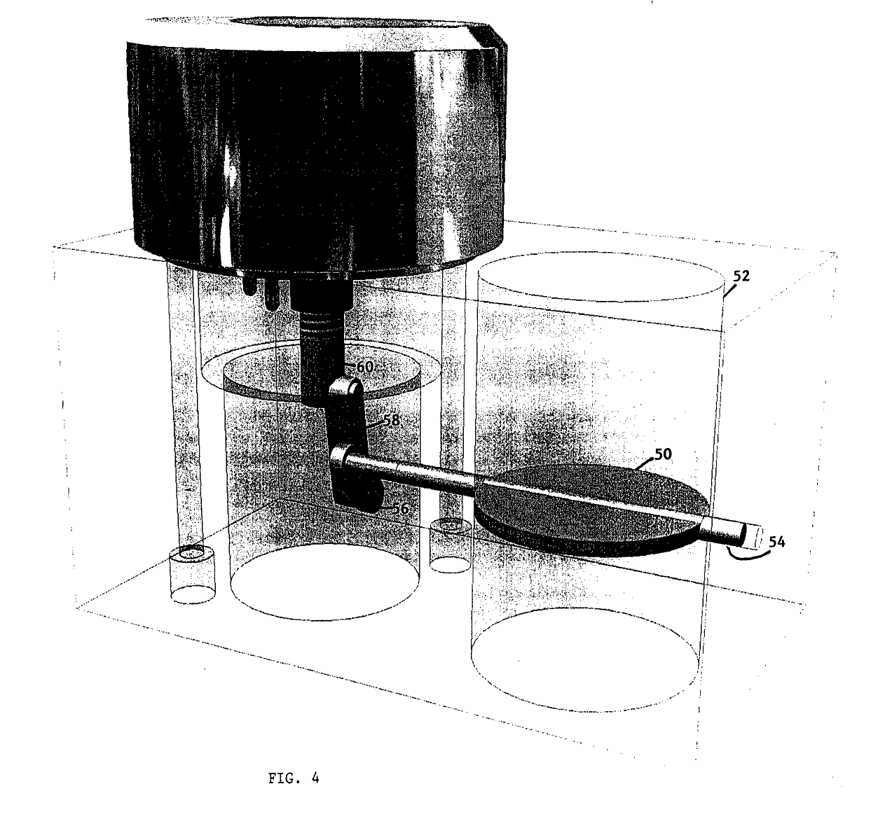

FIG. 4 illustrates, in contrast to the directly coupled embodiments of FIGS. 1 & 2, an indirectly coupled valve, employing a linkage. In this embodiment, a throttle vane 50 is rotatably mounted in a passage 52, turning on a shaft 54. Rotation of shaft 54 is driven by a crank 56 and a connecting rod 58 which follow the up-and-down motions of reciprocating element 60 coupled to the voice coil above. Thus, the reciprocating movement of element 60 is transformed into rotation of vane 50, thereby opening or closing the throttle.

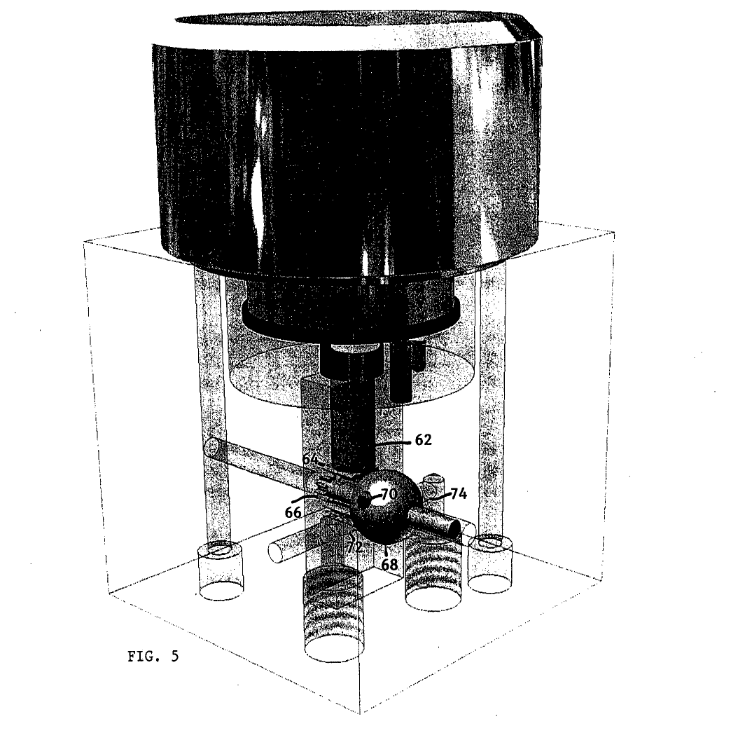

FIG. 5 illustrates yet another indirectly coupled embodiment, in which reciprocating element 62 is formed with a rack 64, which engages a pinion 66 on the shaft of a ball or globe 68. Thereby, a through-passage 70 in ball or globe 68 is rotated into or out of alignment with the inlet and outlet passages 72, 74, opening or closing the valve. For simplicity of illustration, bearing surfaces for the rotatable elements have been omitted from the view.

Those skilled in the art will appreciate that many variations and modifications are possible within the scope of the present invention; for example, features of one embodiment could be combined with features of another embodiment, or a voice coil actuator could be applied to other valve types. Other feedback means, for detecting and adjusting the position of the voice coil with respect to its permanent magnet, are possible. Therefore, the invention is not limited to the embodiments shown and described, but rather is defined by the following claims.

1. An electrically actuated valve comprising
a valve body having an inlet passage, an outlet passage and a movable element arranged between the inlet and outlet for regulating flow through the passages,
a fixed permanent magnet;
a movable coil arranged around the permanent magnet and coupled to the movable element, said coil having a pair of electrical terminals,
whereby application of a control signal current to said movable coil adjusts a position of said movable element within a range between fully closed and fully open.

2. The electrically actuated valve of claim 1,
characterized in that said movable element is a poppet.

3. The electrically actuated valve of claim 1,
characterized in that said movable element is a gate or guillotine.

4. The electrically actuated valve of claim 1, further comprising
a feedback circuit which regulates the position of said movable element toward a desired position.

5. The electrically actuated valve of claim 1,
characterized in that
application of a command signal to fully open said valve results in opening of the valve within 10 milliseconds.

6. An electrically actuated valve comprising
a valve body having an inlet passage, an outlet passage and a linearly movable element which actuates means for regulating flow through the passages,
a fixed permanent magnet;
a movable coil arranged around the permanent magnet and coupled to the movable element, said coil having a pair of electrical terminals, and
a linkage which translates displacement of said linearly movable element into rotation of a gating element arranged between said inlet passage and said outlet passage,
whereby application of a control signal current to said movable coil adjusts a position of said linearly movable element within a range between fully closed and fully open.
